(19) United States
(12) Patent Application Publication
(10) Pub. No.: US 2004/0120472 A1
(43) Pub. Date: Jun. 24, 2004

(54) Voice response system

(76) Inventors: Paul I Popay, Ipswich (GB); Micheal A Harrison, Stonham Parva (GB); Neil L Watton, Ipswich (GB)

Correspondence Address: Nixon & Vanderhye, 8th Floor, 1100 North Glebe Road, Arlington, VA, 22201-4714, US

(21) Appl. No.: 10/474,902

(22) PCT Filed: Apr. 3, 2002
(86) PCT No.: PCT/GB02/01550

(30) Foreign Application Priority Data
Apr. 19, 2001 (EP) 01303597.7

(51) Int. Cl. H04M 1/64; G10L 15/00; G10L 17/00

(52) U.S. Cl. 379/88.01; 704/231; 704/246

(57) ABSTRACT

With interactive voice response services, there are many different ways of asking for the same thing. In this invention the service learns the way in which a user usually asks for certain services and modifies a user specific grammar accordingly. This has the effect of increasing the accuracy of the speech recognition by reducing the number of variants which are expected. The system works well as long as the user does not suddenly start to use new words. In an improved version, the user specific grammar is checked periodically and modified if the user has introduced new words.

### TECHNICAL FIELD

This invention relates to a voice response apparatus and method, particularly although not exclusively for accessing and updating remotely held data using a telephone.

### BACKGROUND TO THE INVENTION AND THE PRIOR ART

In known voice response systems a user's input speech is compared to audio representations of speech units (which may be words or sub words) to determine what the user has said. Usually a representation of sequences of speech units which are expected to be spoken are stored in a grammar also sometimes known as a language model. Often voice response systems will adapt the speech units for each individual user so that the speech units provide a better model for each user's speech as the system is used. Thus the more a user uses the system the better the system is able to recognise that individual's speech.

However, a problem with such a system is that the grammar model does not adapt. For example, in a diary access system one user may always say ‘view my calendar’ whereas another may always say ‘go to my appointments’.

### SUMMARY OF THE INVENTION

According to a first aspect of the present invention there is provided a voice response apparatus comprising

a store for storing user grammar data corresponding to a user;

a speech recogniser for recognising an utterance in dependence upon stored user grammar data and for generating a word or sequence of words to which the utterance is determined to be most similar; and

a grammar updater for updating user grammar data corresponding to a user in dependence upon words generated by the speech recogniser for utterances received from said user.

A problem with such a system is that if a user starts to use words which have been effectively removed from a grammar because the user did not use those words previously the apparatus will not work effectively. Therefore preferably the apparatus further comprises

a store for storing user speech data corresponding to a particular user;

a store for storing generic grammar data;

a speech recogniser for recognising an utterance in dependence upon stored generic grammar data and for generating a word or sequence of words to which the utterance is determined to be most similar; and

a grammar data checker for updating user grammar data corresponding to a user in dependence upon words generated by the speech recogniser for utterances received from said user.

According to another aspect of the invention there is provided a method of operating a voice response apparatus comprising the steps of

receiving an utterance form a user;

recognising the utterance in dependence upon user grammar data corresponding to said user;

generating a word or sequence of words to which the utterance is determined to be most similar;

updating the user grammar data in dependence upon said generated sequence.

Similarly to the apparatus case, a problem with such a method is that if a user starts to use words which have been effectively removed from a grammar because the user did not use those words previously the method will not work effectively. Therefore preferably the method further comprises

recognising the utterance in dependence upon generic grammar data;

generating a word or sequence of words to which the utterance is determined to be most similar;

updating the user grammar data in dependence upon said generated sequence.

### BRIEF DESCRIPTION OF THE DRAWINGS

An embodiment of the present invention will now be described, presented by way of example only, with reference to the accompanying drawings in which:

FIG. 1 is a schematic representation of a computer loaded with software embodying the present invention;

FIG. 2 shows an architecture of a natural language system embodying the present invention;

FIG. 3 illustrates a grammar data updater according to the present invention; and

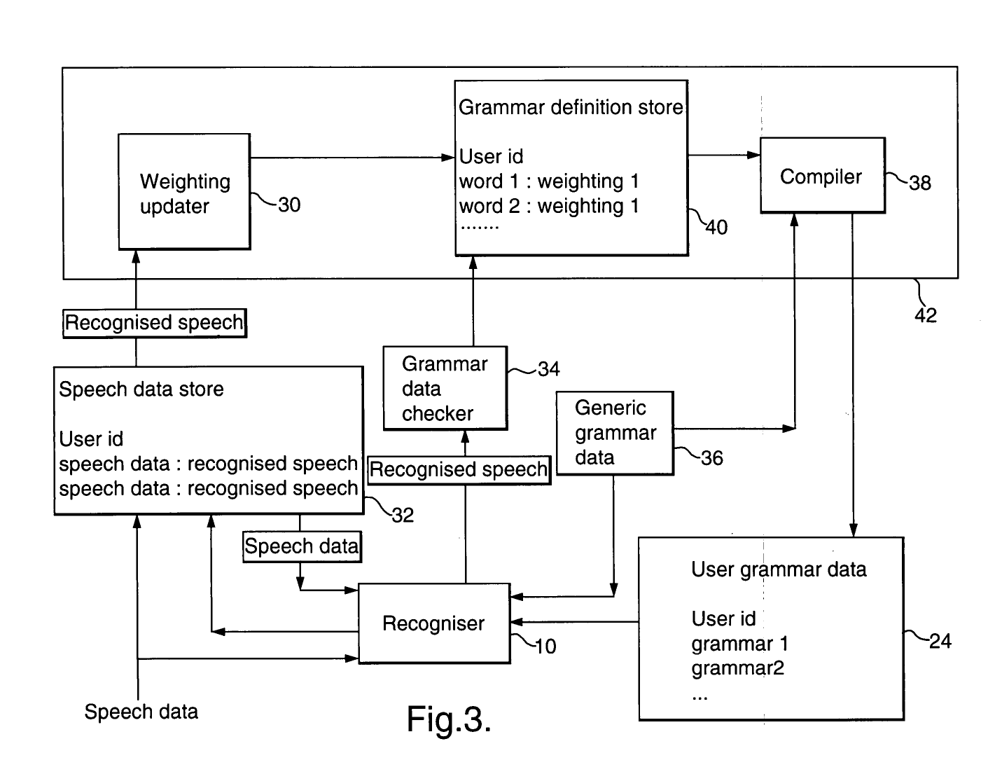

FIG. 4 illustrates part of the user dialogue data store of FIG. 1.

### DESCRIPTION OF THE PREFERRED EMBODIMENT

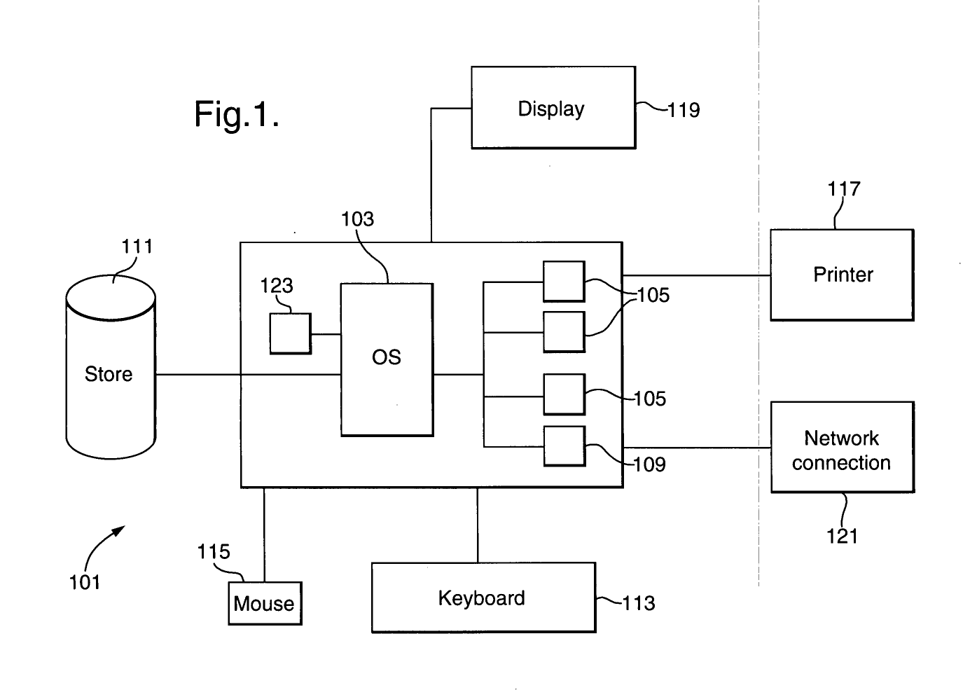

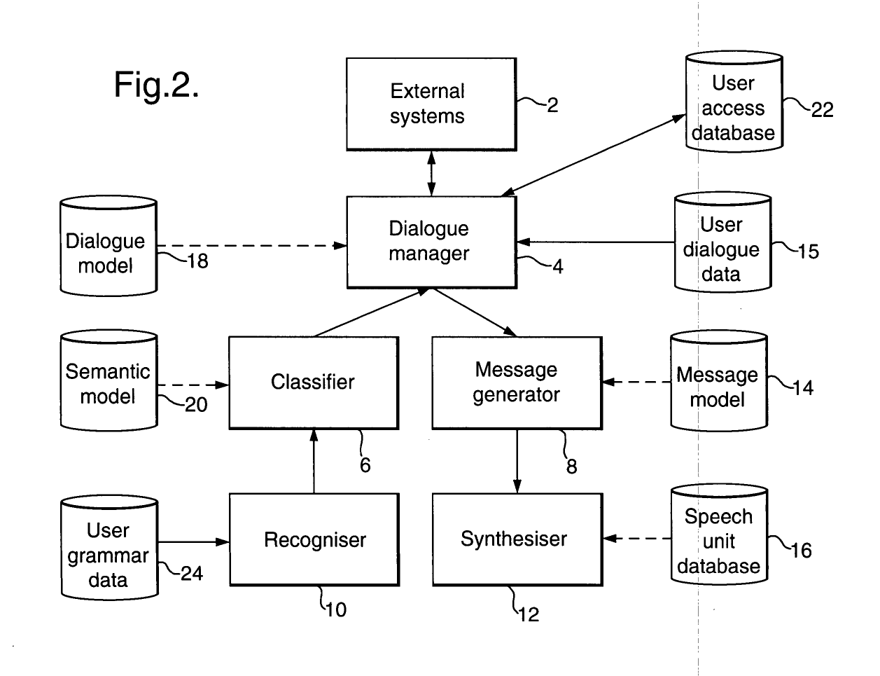

FIG. 1 illustrates a conventional computer 101, such as a Personal Computer, generally referred to as a PC, running a conventional operating system 103, such as Windows (a Registered Trade Mark of Microsoft Corporation), having a store 123 and having a number of resident application programs 105 such as an e-mail program, a text to speech synthesiser, a speech recogniser, a telephone interface program or a database management program. The computer 101 also has a program 109 which together with data stored in the store 123, and resident application programs provides an interactive voice response system as described below with reference to FIG. 2.

The computer 101 is connected to a conventional disc storage unit 111 for storing data and programs, a keyboard 113 and mouse 115 for allowing user input and a printer 117 and display unit 119 for providing output from the computer 101. The computer 101 also has access to external networks (not shown) via a network connection card 121.

FIG. 2 shows an architecture of an embodiment of the interactive voice response system according to this invention. A user's speech utterance is received by a speech recogniser 10. The received speech utterance is analysed by the recogniser 10 with reference to a user grammar data store 24. The user grammar data store 24 represents sequences of words or sub-words which can be recognised by the recogniser 10 and the probability of these sequences occurring. The recogniser 10 analyses the received speech utterance, with reference to speech units which are held in a speech unit database 16, and provides as an output a representation of sequences of words or sub-words which most closely resemble the received speech utterance. In this embodiment of the invention the representation comprises the most likely sequence of words or sub-words, in other embodiments the representation could be a graph of the mostly likely sequences.

Recognition results are expected to be error prone, and certain words or phrases will be much more important to the meaning of the input utterance that others. Thus, confidence values associated with each word in the output representation are also provided. The confidence values give a measure related to the likelihood that the associated word has been correctly recognised by the recogniser 10. The output graph including the confidence measures are received by a classifier 6, which classifies the received graph according to a predefined set of meanings, with reference to a semantic model 20 (which is one of a plurality (not shown) of possible semantic models) to form a semantic classification. The semantic classification comprises a vector of likelihoods, each likelihood relating to a particular one of the predefined set of meanings. A dialogue manager 4 operates using a state based dialogue model 18 as will be described more fully later. The dialogue manager 4 uses the semantic classification vector and information about the current dialogue state together with information from the dialogue model 18 and user dialogue data 15 to instruct a message generator 8 to generate a message, which is spoken to the user via a speech synthesiser 12. The message generator 8 uses information from a message model 14 to construct appropriate messages. The speech synthesiser uses a speech unit database 16 which contains speech units representing a particular voice. The dialogue manager 4 also instructs the recogniser 10 which user grammar to use from the user grammar data store 24 for recognising a received response to the generated message, and also instructs the classifier 6 as to the semantic model to use for classification of the received response. The dialogue manager 4 interfaces to other systems 2 (for example, a customer records database).

When a user calls the system the user is asked for a unique user identifier and a personal identification number. If the data entered by the user (which may be spoken or entered using a telephone keypad) matches an entry in a user access database 22 then they are allowed access to the service.

The dialogue model 18 comprises a plurality of states connected together by interconnecting edges. A caller moves to a particular state by speaking a one of several words or phases which are classified by the classifier 6 as having a particular meaning. To use the example above, ‘view my calendar’ and ‘go to my appointments’ may be classified as meaning the same thing as far as the dialogue is concerned, and may take the user to a particular dairy access state.

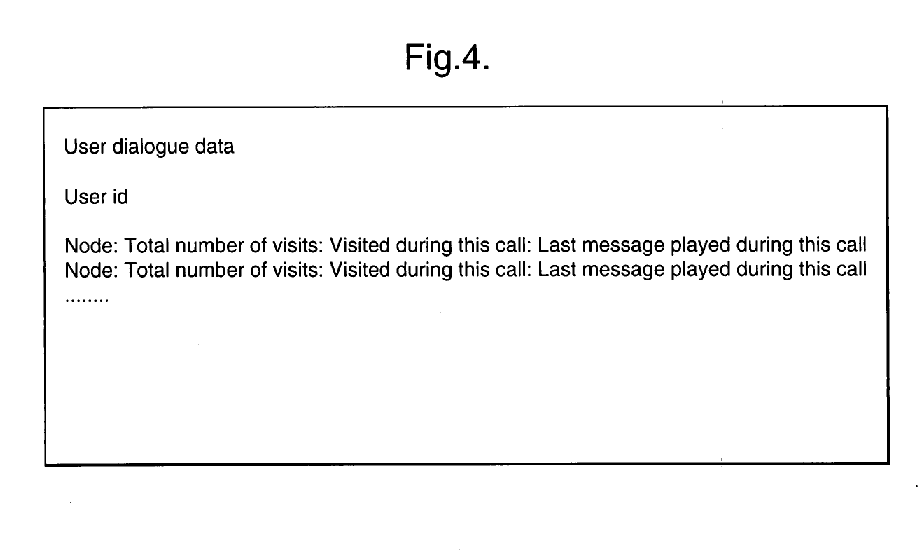

The user dialogue data store 15 stores a count of the number of times a user has visited a particular state in the dialogue model. FIG. 4 shows schematically the contents of the user dialogue data store 15.

Once a user is in a particular state the dialogue manager instructs the message generator to play a message to the caller to guide them as to the actions they may perform. The verbosity of the message depends upon the count of the number of times the user had previously visited that state, which is stored in the user dialogue data store 15. When a new user calls the system, the message used will be verbose as the count will be equal to 0. The messages become more concise as the stored count for that state increases i.e. each time an individual user uses the state, whether or not the use of the state is during a single call or whether the use is during a later call to the system. The count values stored in the store 15 may be updated periodically to reduce the value if a particular user has not used a particular state recently, therefore the messages will become more verbose over time should a user not enter that state in subsequent calls, or if a user has not used the system for some time.

The user dialogue data store 15 also stores a Boolean flag indicating whether or not a user has visited a particular state in the dialogue model within a particular call, together with a record of the message which was played to the user the last time that state was visited. When the user visits the same state on more than one occasion during a particular call, messages will be selected by the dialogue manager 4 to ensure a different message is played to that played last time the state was visited during the call. This avoids the repetition that human factors analysis shows detrimentally affects the likelihood of a user reusing the system. For any sate with potential repetition, there are a plurality of messages stored in the message model store 14, with the next message to be used randomly selected from the set not including the message used previously (which is stored in the user dialogue data store 15).

In order to tailor the system to a particular user so that the system becomes easier to use as the system is used more, each time a user calls the system data is stored in a speech data store 32. Speech data received from the user is recognised by the recogniser 10 with reference to the user grammar data store 24. Initially before any calls have been made by a user the user grammar data is identical to generic grammar data stored in a generic grammar data store 36.

The speech data store 32 stores for each user speech data along with the sequences of words or sub-words which were recognised by the recogniser 10. After each call the recognised speech is used by a weighting updater 30 to update weighting values for words which have been recognised in a grammar definition store 40. For the particular user who made the call the words which have been recognised have a weighting value increased. In other embodiments of the invention words which have not been used also have their weighting value decreased. Once a day a compiler 38 is used to update the user grammar data store 42 according to the weighting values stored in the grammar definition store 40. A method of updating a grammar for a speech recogniser according to provided weighting values is described in our co-pending patent application no EP96904973.3. Together the weighting updater 30, the grammar definition store 40 and the compiler 38 provide the grammar updater 42 of the present invention.

Recognised speech does not need to be stored in a speech data store, in other embodiments of the invention recognised speech may be used to update user grammar data in a single process which may be carried out immediately. Furthermore it will be understood that the updating process could take at predetermined time intervals as described above, or could conveniently be done whenever there is spare processing power available, for example when there are no calls in progress.

The result of the use of the compiler 38 is that words or phrases which a particular user uses more frequently are given a higher weighting in the user grammar data store 24 than those which are hardly ever used. It is possible in fact to effectively delete words from a particular user grammar by providing a weighting value of 0. Of course, it may happen that a user starts to use words which have not been used previously. The recogniser 10 may not recognise these words due to the fact that these words have a very low weighting value associated with them for that user in the user grammar data store 42. In order to prevent this problem the users speech which has been stored in the speech data store 32 is periodically recognised by the speech recogniser 10 using generic grammar data 36, and the recognised speech is sent to a grammar data checker 34 which checks that no words have been recognised which have been previously been given a very low weighting. If this is the case then the weighting value for that word will be updated accordingly, and the compiler 38 is used to update the user grammar data store 42 according to the updated weighting values stored in the grammar definition store 40.

Whilst this invention has been described with reference to stores 32, 40, 42 which store data for each user it will be understood that this data could be organised in any number of ways, for example there could be a separate store for each user, or store 42 could be organised as a separate store for each grammar for each user.

As will be understood by those skilled in the art, the interactive voice response program 109 can be contained on various transmission and/or storage mediums such as a floppy disc, CD-ROM, or magnetic tape so that the program can be loaded onto one or more general purpose computers or could be downloaded over a computer network using a suitable transmission medium.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A voice response apparatus comprising
a store for storing user grammar data corresponding to a user;
a speech recogniser for recognising an utterance in dependence upon stored user grammar data and for generating a word or sequence of words to which the utterance is determined to be most similar; and
a grammar updater for updating user grammar data corresponding to a user in dependence upon words generated by the speech recogniser for utterances received from said user.

2. An apparatus according to claim 1 further comprising
a store for storing user speech data corresponding to a particular user;
a store for storing generic grammar data;
a speech recogniser for recognising an utterance in dependence upon stored generic grammar data and for generating a word or sequence of words to which the utterance is determined to be most similar; and
a grammar data checker for updating user grammar data corresponding to a user in dependence upon words generated by the speech recogniser for utterances received from said user.

3. A method of operating a voice response apparatus comprising the steps of
receiving an utterance from a user;
recognising the utterance in dependence upon user grammar data corresponding to said user;
generating a word or sequence of words to which the utterance is determined to be most similar;
updating the user grammar data in dependence upon said generated sequence.

4. A method according to claim 3, and further comprising the steps of
recognising the utterance in dependence upon generic grammar data;
generating a word or sequence of words to which the utterance is determined to be most similar;
updating the user grammar data in dependence upon said generated sequence.
